(19) United States
(12) Patent Application Publication
(10) Pub. No.: US 2021/0296022 A1
(43) Pub. Date: Sep. 23, 2021

(54) ELECTRICAL COMPONENT AND METHOD

(71) Applicant: Siemens Aktiengesellschaft, Munich (DE)

(72) Inventor: Daniel Walton, Morecambe (GB)

(73) Assignee: Siemens Aktiengesellschaft, Munich (DE)

(21) Appl. No.: 16/317,558

(22) PCT Filed: Jul. 20, 2017
(86) PCT No.: PCT/EP2017/068339

§ 371 Date: Jan. 13, 2019

(30) Foreign Application Priority Data
Jul. 22, 2016 (EP) 16180807.6

(51) Int. Cl. H01B 3/00; H01R 13/523; H01R 43/00; H01B 13/14; H01B 7/04; C08K 3/04; C08K 7/00

(52) U.S. Cl. CPC H01B 3/004; H01R 13/523; H01R 43/005; H01B 13/141; H01B 3/28; H01B 7/045; C08K 3/042; C08K 7/00; H01B 13/148

(57) ABSTRACT

A subsea electrical connector or electrical cable having a conductor, an insulator coaxial with the conductor; and at least one of a volumetric compensating diaphragm located radially outwardly of the insulator, or a termination boot. The diaphragm or termination boot has a compound layer, the compound layer includes a graphene nano-platelet additive incorporated into a cross-linked polymer matrix to produce a polymer composite.

### CROSS REFERENCE TO RELATED APPLICATIONS

This application is the US National Stage of International Application No. PCT/EP2017/068339 filed Jul. 20, 2017, and claims the benefit thereof. The International Application claims the benefit of European Application No. EP16180807 filed Jul. 22, 2016. All of the applications are incorporated by reference herein in their entirety.

### FIELD OF INVENTION

This invention relates to an electrical component for subsea applications, such as for subsea connectors, cables, or subsea electrical equipment.

### BACKGROUND OF INVENTION

It is recognized within the subsea industry that permeation of liquid and gas media into electrically insulating materials can significantly reduce their electrical insulation resistance, rendering equipment inoperable.

Many of these electrically insulating materials are required to be dynamic. For example, subsea cables flex with underwater currents and dielectric oils flow and expand as they are heated and cooled during service.

### SUMMARY OF INVENTION

In accordance with a first aspect of the present invention a subsea electrical connector or electrical cable comprises a conductor, an insulator coaxial with the conductor; and at least one of a volumetric compensating diaphragm located radially outwardly of the insulator, or a termination boot; wherein the diaphragm or termination boot comprises a compound layer, the compound layer comprising a graphene nano-platelet additive incorporated into a cross-linked polymer matrix to produce a polymer composite.

The polymer composite provides a flexible layer, resistant to permeation of sea water through the flexible layer. The graphene nano-platelet (GNP) additive improves the resistance to permeation by sea water of the cross linked polymer matrix, as compared to a cross linked polymer matrix without a GNP additive.

The connector or cable may comprise both a termination boot and a volumetric compensating diaphragm.

The proportion of graphene nano-platelet additive expressed in parts per hundred rubber (PHR) may be between 0.1 and 5.0.

The proportion of graphene nano-platelet additive PHR may be between 0.1 and 1.0, in particular between 0.1 and 0.5, or between 0.5 and 1.0.

Preferably, the compound layer is in physical contact with at least part of the insulator.

Preferably, the compound layer forms a sealed chamber containing an insulating liquid.

Preferably, the cross-linked polymer matrix comprises an elastomer. The elastomer may comprise one of styrene-butadiene rubber, nitrile rubber, hydrogenated nitrile rubber, chloroprene rubber, ethylene propylene diene rubber, fluoro elastomers, perfluoro elastomers, silicone rubber, or fluoro silicone rubber.

In accordance with a second aspect of the present invention, a method of manufacturing a component of an electrical connector, or electrical cable, the component comprising a volumetric compensating diaphragm, or a termination boot, comprises creating a compound layer of the component by determining proportions of graphene nano-platelets and a cross-linked polymer matrix for the component; incorporating the graphene nano-platelets into the cross-linked polymer matrix in the determined proportions to produce a polymer composite; and forming the component from the polymer composite.

The method may further comprise aligning the graphene nano-platelets in the same direction, perpendicular to a diffusion path of water through the component.

This improves the permeation resistance of the material via the tortuous path model. The greater the angle at which the graphene nano platelets are orientated relative to the diffusion path of water through the diaphragm, the better the performance achieved.

The method may further comprise moulding an elastomer through a transfer moulding process by transferring the polymer composite into the mould cavity under pressure through a small orifice to induces a high shear rate on the compound.

This in turn causes the graphene nano-platelets to orientate in the flow direction.

Preferably, the method further comprises providing a cure system in the polymer composite and applying thermal treatment to the polymer composite, causing the polymer to cross-link, to form the component.

The proportion of graphene nano-platelet additive may be between 0.1 PHR and 5.0 PHR. For example, the proportion of graphene nano-platelet additive may be between 0.1 PHR and 1.0 PHR, in particular between 0.2 PHR and 0.5 PHR, or between 0.5 PHR and 1.0 PHR.

Preferably, a desired maximum leakage rate is chosen and the corresponding proportion of graphene nano-platelets is determined for the polymer matrix by extracting values from a store.

In accordance with a third aspect of the present invention, a method of manufacturing a subsea connector, or subsea cable comprises manufacturing a component of an electrical connector or electrical cable according to the method of the second aspect; and coupling the component to an insulating layer of the connector, or cable.

In accordance with a fourth aspect of the present invention, a method of manufacturing a subsea connector, or subsea cable comprises manufacturing a component of an electrical connector or electrical cable by a method according to the second aspect, wherein the forming comprises over-moulding the polymer composite onto the insulating layer, or co-extruding the polymer composite with the insulating layer of the electrical connector or electrical cable.

### BRIEF DESCRIPTION OF THE DRAWINGS

An example of a component in accordance with the present invention will now be described with reference to the accompanying drawings in which:

FIG. 1 illustrates an example of a subsea cable in which the present invention may be applied;

FIG. 2 illustrates an example of a subsea connector in which the present invention may be applied;

FIG. 3 illustrates the process by which a component for use in the cable or connector of FIGS. 1 and 2 may be produced;

FIG. 4 illustrates test results for a component made by a method according to the invention.

### DETAILED DESCRIPTION OF INVENTION

As discussed above, subsea cables need to be able to flex with underwater currents and where dielectric oils are used, for example in subsea cable connectors, these flow and expand as they are heated and cooled during service. Maintaining the electrical insulation of subsea cables, or connectors, in such circumstances can be challenging. There are also circumstances in which it is desirable to provide an electrically conductive layer outside the insulating layer of a cable, or a connector in order to contain the electrical field within the cable insulation. The additional electrically conductive layer allows for a smooth, continuous earth screen in intimate contact with the insulation minimising the chances of air, contamination or sharp geometries adversely affecting the performance of the cable. Subsea electrical equipment having electrical insulation which is bounded by a conductive medium has the advantage that electrical stresses are contained within a predefined, purpose engineered region, thus increasing the reliability of the electrical insulation (i.e. reduces partial discharges). Furthermore, this results in regions outside the earth screen not being electrically stressed and so allows for a wider variety of materials and engineering techniques to be used for other functions, such as mechanical support or pressure compensation.

Materials having the required flexibility include elastomers, yet to give the elastomeric material the required resistance to gas or liquid permeation and so reduce the permeation rates through the elastomer, it is necessary to introduce additives. One example is to introduce a two dimensional material into the polymer matrix to increase the length of the diffusion path that molecules must travel in order to pass through the elastomer. Nano-clays may be used to increase the diffusion path, but nano-clays by their very nature are electrically insulating, albeit chemically inert. Metal flake may also be used to reduce permeation by increasing the diffusion path, and the material including metal flakes may also become conductive. Aluminium is commonly used due to its low cost and wide availability. However, metal flakes may tarnish, oxidize and corrode when exposed to liquid and/or gas media for prolonged periods, so the permeation resistance and conductance reduces over time. Conductivity in elastomers may be controlled by the size, loading and dispersion of 3-dimensional carbon particles within the polymer matrix. This may be achieved with varying grades of carbon blacks (typically used for re-enforcing polymers) or more recently carbon nano-tubes, but these are very expensive to manufacture.

In the present invention, providing the desired level of mechanical flexibility, permeation resistance and conduction in components of a cable connector is addressed by providing a flexible material in which permeation of liquid and/or gas media through the material is inhibited, whilst, at the same time, introducing electrical conductivity into the material by incorporation of a second material into a base material. The second material provides the benefits of both increasing the diffusion path length and providing conductivity, without the complications of using multiple additives having different properties and different drawbacks.

The flexible base material of the present invention may comprise a lightly cross-linked thermosetting polymer. A suitable polymer, for example, is an elastomer, such as natural or synthetic rubber. The cross-linked polymer structure constitutes a polymer matrix into which additives are incorporated. Permeation of liquid and/or gas media through the material is inhibited by addition of a two dimensional additive and the same two dimensional additive also provides electrical conductivity. In the examples described, this additive is graphene, which is compounded into the polymer matrix before any thermal treatment is applied. The polymer may be a silicone polymer (siloxane), or a hydrocarbon polymer. Any elastomers with suitable properties may be used for the polymer matrix, for example styrene-butadiene rubber, nitrile rubber, hydrogenated nitrile rubber, chloroprene rubber, ethylene propylene diene rubber, fluoro elastomers, perfluoro elastomers, silicone rubber, or fluoro silicone rubber.

For the examples given, a silicone polymer matrix may be used and two dimensional non-oxidised graphene nano-platelets may be compounded into the polymer matrix to form an elastomer graphene nanocomposite. The graphene may be incorporated and dispersed within the silicone matrix in a ‘z-blade’ mixer, prior to thermal processing, but other types of mixing may be used. In addition, a cure system is incorporated and after mixing the compound is thermally treated. During the manufacturing process there may be other additives added to achieve particular properties of the polymer matrix composite, for example mechanical properties, or curing.

The proportion of any material added to the polymer matrix, whatever its purpose, relative to the polymer matrix may be expressed in parts per hundred rubber (PHR). The expression PHR refers to the number of parts of the additive per 100 by weight of the rubber. Thus, for the examples given, the amount of graphene nano-platelets, or a curing additive, or other required additive to be added to the base material, in this case a cross linked polymer matrix, or elastomer, typically a rubber polymer, may be defined in terms of PHR.

The resulting material is a flexible, low permeation, conductive material which may then be applied as a protective barrier over electrical insulation. The barrier layer may be over-moulded, co-extruded with the electrical insulation layer, or manufactured separately and then assembled around a conductor.

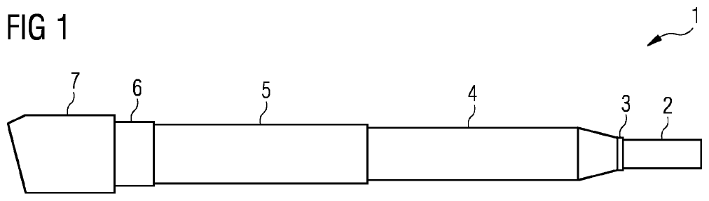

An example of a subsea cable in which the present invention may be used is illustrated in FIG. 1. A screened cable 1 typically comprises a conductor 2, an inner semi-conductive layer 3, an insulation layer 4, typically a solid insulation layer, such as polymeric insulation, an outer semi-conductive layer 5, an earth screen 6 and outer jacket 7. The function of the outer, semi-conductive layer is to provide a smooth, continuous earth screen which contains the electrical field within the cable's engineered insulation and minimizes the chances of air, contamination or sharp geometries, which act as electrical stress raisers, adversely affecting the performance of the cable. In addition, a water blocking layer (not shown) may be added, but this adds cost and complexity to the manufacturing process.

Using the polymer composite of the present invention in a subsea cable for the outer semi-conductive layer 5 of the cable 1 improves performance by protecting the cable from permeation of gas or liquid and providing a conducting layer outside the insulation layer 4. The outer semi-conductive layer may be an elastomer with one or more additives added to the elastomer during the manufacturing process, The addition of grapheme both reduces permeation of gas, or liquid and provides conductivity in the layer between the electrical insulation and earth screen. Other additives, for example the cure system for curing the polymer compound when thermal treatment is applied, may also be included in the compound.

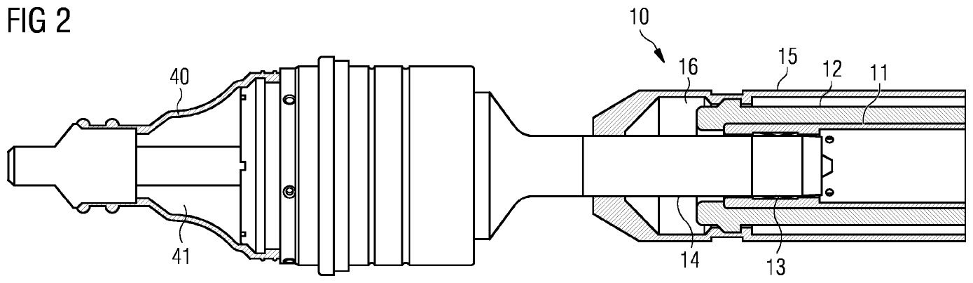

An example of a subsea connector using a polymer composite layer according to the present invention is shown in FIG. 2. The connector 10 comprises a socket including socket conductor 11 and socket insulation 12, together with a pin including pin conductor 13 and pin insulation 14. A volumetric compensating diaphragm 15 surrounds the pin and socket, forming an oil filled chamber 16 in the region around the pin and an oil filled chamber 17 in the area between the diaphragm and socket insulator. Typically dielectric insulating oil in these chambers 16, 17 provides additional insulation around the pin insulation 14 and around the socket insulation 12. The electrically conducting diaphragm provides electrical field control and grounding. In some instances, these conductive elastomers are used in volumetric compensating diaphragms of insulating oil filled chambers. The diaphragm 15 of the mated connectors benefits from being made of the polymer composite of the present invention, so that the pin and socket are protected more effectively against the external elements and have the benefit of a conductive layer outside their insulating layers.

An electrical connector, or electrical cable may be manufactured by forming a component from a polymer composite, with the desired properties for which the required proportions of a lightly cross-linked polymer matrix and additives have been determined, then incorporating the additives into the polymer matrix in the determined proportions prior to thermal processing and subsequent cross-linking, to produce the polymer composite. The desired properties may be for example, maximum leakage rate. The corresponding proportion of polymer and graphene may then be extracted from a store, or calculated. The polymer composite may then be made by compounding 2-dimensional graphene nano-platelets into the polymer matrix, along with any other additives required, such as the cure system. Having made the component, then the other parts of the subsea connector, or subsea cable are obtained and assembled in the required order, including coupling the component to an insulating layer of the connector, or cable. In some cases, the component is formed by over-moulding the polymer composite onto the insulating layer, or co-extruding the polymer composite with the insulating layer of the electrical connector or electrical cable, although it may be made separately and then added as part of the assembly process.

The electrical connector or electrical cable typically comprises a conductor, an insulator coaxial with the conductor and a compound layer, the component having the desired properties of gas and liquid permeation rates and electrical conductivity, is located radially outwardly of the insulator. The compound layer is in physical contact with at least part of the insulator, which may include different insulator parts, such as the pin insulator or the socket insulator. The compound layer may contact the insulator at specific locations in order to form one or more sealed chambers, for example for containing an insulating liquid.

The cross-linked polymer matrix may comprise an elastomer, or other cross-linked polymer matrix having the required properties of flexibility for the application.

Although any elastomeric material may be used for the polymer composite of the present invention, silicone is advantageous due to its flexibility at low temperatures and good thermal stability, as well as its chemical resistance to both sea water and insulating oil. The desired operating temperature range for subsea connectors and cables may be from −25° C. to greater than 150° C.

The main application of the present invention in subsea connectors is for components incorporating these elastomer compounds, such as compensation diaphragms and termination boots, as illustrated in FIG. 2. A termination boot 40 has similar requirements to the compensation diaphragm 15 except that the termination boot 40 does not contain de-matable contacts. The electrical contact is fixed (for example, a crimped cable) and the boot 40 is usually filled with a potting compound 41, such as an room temperature vulcanisation RTV silicone, or similar which cures and provides electrical insulation.

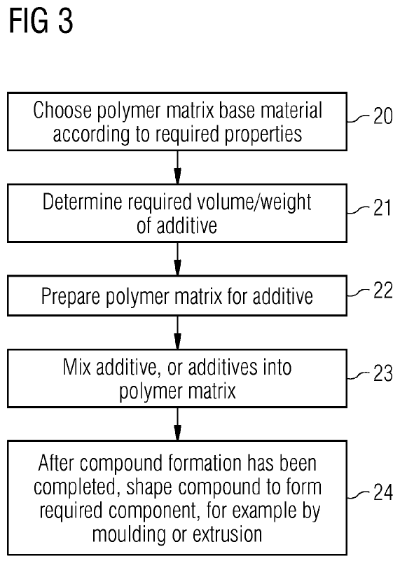

Graphene nano-platelets (GNP's) are commercially available and may be manufactured using various techniques, for example using a process as described in WO2014140324. FIG. 3 is a flow diagram of the process by which the polymer composite layer is manufactured, which can then be used in subsea cables, or connectors. The polymer matrix base material is chosen 20 to meet the required properties in terms of mechanical properties across operating temperature range and chemical compatibility with contact fluids, including tensile, compression set, elongation, flexibility, or stiffness properties. The desired maximum leakage rate may be determined and from that the amount in PHR of each additive may also be derived 21. This may be by means of a look up table, using data from performance of previously manufactured components, or by calculation, to achieve the desired performance properties in terms of gas or liquid permeation and conductivity of the component. The polymer matrix is then prepared 22 for the additives to be added. The determined proportion in PHR of the, or each, of the additives is added 23 to the polymer matrix and a compound is formed.

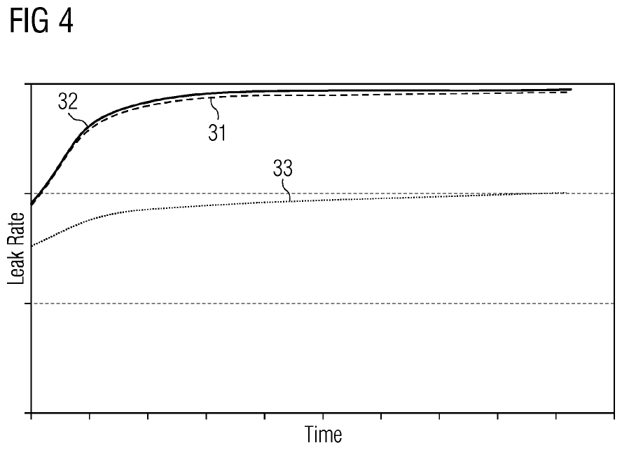

Each polymer/graphene composite may be characterised for its own diffusion properties. The graphene may be incorporated into the polymer matrix by mixing. Typical mixing might be performed in a Banbury mixer, however mixing silicone compounds is advantageously done in a mixer such as a ‘z-blade’. In the example tested in FIG. 4, described below, the secondary material used was two-dimensional non-oxidised graphene nano-platelets compounded into the polymer matrix. For graphene platelets manufactured by an exfoliation process whereby larger pieces of graphite are subject to shocks which essentially break the electrostatic forces holding the graphite layers together to form platelets, as described in WO2014140324, the graphene is just carbon and remains as such in normal service environments. Graphene platelets may be manufactured by other methods, such as producing GNP's by oxidising graphite in order to make the graphite hydrophilic and then exfoliating the graphite in water using sonication. However, this results in graphene oxide platelets which then have to be chemically reduced to get graphene, so non-oxidised graphene platelets are advantageous. After compound formation, the compound is shaped 24 to form the required component, for example by moulding or extrusion. This may be part of the overall process of forming the connector, or cable, or it may be a separate step and the component is added to the connector or cable as a pre-formed entity.

The atomically thin nature and resulting high aspect ratio of non-oxidised graphene nano-platelets, combined with substantially uniform dispersion of the GNPs within the polymer matrix, significantly reduces the permeation rate of liquid and/or gas media through the polymer as described by the ‘tortuous path’ model—GNP's are impermeable and any liquid/gas is forced to diffuse around each GNP, increasing the diffusion path length, and hence diffusion rate through the polymer, by many orders of magnitude. Graphene is an excellent electrical and thermal conductor. The atomically thin size and large aspect ratio of the GNP's allows them to come within sufficiently close proximity to enable conduction.

The performance of subsea electrical equipment is improved by encasing the electrical insulation within a conductive material, thus allowing for the control of electrical fields. In addition, it is desirable to separate the electrical insulation from contamination by external liquid or gas media, such as sea water, that may reduce electrical insulation properties. By incorporating graphene into the polymer matrix the present invention provides a protective barrier for a subsea connector, or cable, which is still flexible, yet significantly less permeable than conventional insulating sheaths and may be made sufficiently conductive to contain electrical stresses. Graphene is a single additive applied to the polymer matrix which is able to provide the desired improvements in all properties.

FIG. 4 illustrates helium leak test results for a polymer matrix into which graphene nano-platelets have been incorporated. For this test the polymer matrix was silicone. The silicone and the other additives were pre-mixed and then a percentage by weight graphene was added. Elastomer graphene nano-composites having different proportions of graphene nano-platelets incorporated into the polymer matrix were tested and the test results obtained for each of the chosen proportions can be seen in FIG. 4. The test was run for the same period for each proportion that was tested. Tests 31, 32 were carried out for graphene nanoplatelet additive incorporated into the elastomer at proportions of 2% fill by volume and 5% fill by volume respectively. It can be seen that for both the 2% and 5% elastomer graphene nano-composites, the leakage rate came close to a steady state at a very similar level within the test period. However, for a 10% fill by volume, illustrated by line 33, significant improvement was obtained, in that the helium leakage rate approached a steady state at a much lower leakage rate than with a 2% or 5% fill.

The proportion of graphene nano-platelet additive depends upon the required improvement in performance for a particular application, taking into account aspects, such as cost and other additives. In a trial using hydrogenated nitrile rubber to which graphene nano-platelets were added as the sole additive, the mechanical properties of the elastomer compound were improved. The loading in these examples is expressed in PHR. A range may be between 0.1 PHR and SPHR, more particularly between 0.1 PHR and 1 PHR or 0.5 PHR and 1 PHR. Effective results were achieved with up to 1 part per hundred rubber loading. Some further improvements in performance were observed with loadings at SPHR, although between 0.1 PHR and 1 PHR graphene loading is advantageous to achieve a reasonable improvement in the mechanical properties for the amount of additive. Some minor agglomeration of the GNP's was observed in the graphene only samples indicating that it may be beneficial to pre-disperse the GNP's in a carrier, such as an oil (mineral, synthetic, silicone etc.), monomer, solvent or aqueous solution, and then incorporate this into the compound.

A particularly effective combination results from graphene nano-platelets in combination with traditional carbon black being added to the hydrogenated nitrile rubber. In this case, the mechanical properties observed where better than either the solely GNP or solely carbon black results. Again, noticeable improvements were achieved with up to 1 PHR loading and only limited further improvements with SPHR, indicating an advantage for between 0.1 PHR and 1 PHR for optimising the results relative to the amount of additive used. Above 5 PHR, the increase in viscosity may lead to unstable moulding conditions of the compound into the final article.

Alignment of the GNP's in the same direction, i.e. perpendicular to the diffusion path of water through a diaphragm, improves the permeation resistance of the material via the tortuous path model. The greater the orientation, the better the performance achieved. Elastomer compounds are generally moulded into final articles through a transfer moulding process. The compound is transferred into the mould cavity under high pressure through a small orifice, or gate, that induces a high shear rate on the compound. This in turn causes the GNP's to orientate in the flow direction. Careful tool design that ensures this flow direction continues into the final article such that it is perpendicular to the diffusion path of water, leads to optimum properties.

The elastomer composite described provides a flexible, significantly less permeable, yet conductive material for use in the manufacture of, for example, compensating diaphragms for subsea dielectric oil filled chambers, or flexible semi-conductive layers for subsea cables. The composite has better permeation control and electrical field control than an unmodified elastomer. In terms of manufacturing, the process is simplified because a single additional material is incorporated into a polymer matrix, whereas conventional attempts to improve permeation control or electric field control required multiple additives to achieve the desired properties.

1. A subsea electrical connector or electrical cable, comprising:
a conductor,
an insulator coaxial with the conductor; and
at least one of a volumetric compensating diaphragm located radially outwardly of the insulator, or a termination boot;
wherein the diaphragm or termination boot comprises a compound layer, the compound layer comprising a graphene nano-platelet additive incorporated into a cross-linked polymer matrix to produce a polymer composite.

2. The subsea electrical connector or electrical cable according to claim 1,
wherein the subsea electrical connector or electrical cable comprises both a termination boot and a volumetric compensating diaphragm.

3. The subsea electrical connector or electrical cable according to claim 1,
wherein a proportion of graphene nano-platelet additive expressed in parts per hundred rubber (PHR) is between 0.1 and 5.0.

4. The subsea electrical connector or electrical cable according to claim 3,
wherein the proportion of graphene nano-platelet additive PHR is between 0.1 and 1.0.

5. The subsea electrical connector or electrical cable according to claim 1,
wherein the compound layer is in physical contact with at least part of the insulator.

6. The subsea electrical connector or electrical cable according to claim 4,
wherein the compound layer forms a sealed chamber containing an insulating liquid.

7. The subsea electrical connector or electrical cable according to claim 4,
wherein the cross-linked polymer matrix comprises an elastomer.

8. The subsea electrical connector or electrical cable according to claim 7,
wherein the elastomer comprises one of styrene-butadiene rubber, nitrile rubber, hydrogenated nitrile rubber, chloroprene rubber, ethylene propylene diene rubber, fluoro elastomers, perfluoro elastomers, silicone rubber, or fluoro silicone rubber.

9. A method of manufacturing a component of a subsea electrical connector, or electrical cable according to claim 1, the component comprising a volumetric compensating diaphragm, or a termination boot, the method comprising:
creating a compound layer of the component by determining proportions of graphene nano-platelets and a cross-linked polymer matrix for the component;
incorporating the graphene nano-platelets into the cross-linked polymer matrix in the determined proportions to produce a polymer composite; and
forming the component from the polymer composite.

10. The method according to claim 9, further comprising:
aligning the graphene nano-platelets in the same direction, perpendicular to a diffusion path of water through the component.

11. The method according to claim 9, further comprising:
moulding an elastomer through a transfer moulding process by transferring the polymer composite into a mould cavity under pressure through a small orifice to induces a high shear rate on the compound.

12. The method according to claim 9, further comprising:
providing a cure system in the polymer composite and applying thermal treatment to the polymer composite, causing the polymer to cross-link, to form the component.

13. The method according to claim 9,
wherein a proportion of graphene nano-platelet additive is between 0.1 PHR and 5.0 PHR.

14. The method according to claim 13,
wherein the proportion of graphene nano-platelet additive is between 0.1 PHR and 1.0 PHR.

15. The method according to claim 9,
wherein a desired maximum leakage rate is chosen and a corresponding proportion of graphene nano platelets is determined for the polymer matrix by extracting values from a store.

16. A method of manufacturing a subsea electrical connector, or electrical cable, the method comprising:
manufacturing a component of a subsea electrical connector or electrical cable by a method according to claim 9; and
coupling the component to an insulating layer of the subsea electrical connector, or electrical cable.

17. A method of manufacturing a subsea electrical connector, or electrical cable, the method comprising:
manufacturing a component of a subsea electrical connector or electrical cable by a method according to claim 9,
wherein the forming comprises over-moulding the polymer composite onto an insulating layer, or co-extruding the polymer composite with the insulating layer of the subsea electrical connector or electrical cable.

18. The subsea electrical connector or electrical cable according to claim 3,
wherein the proportion of graphene nano-platelet additive PHR is between 0.1 and 0.5

19. The subsea electrical connector or electrical cable according to claim 3,
wherein the proportion of graphene nano-platelet additive PHR is between 0.5 and 1.0.

20. The method according to claim 13,
wherein the proportion of graphene nano-platelet additive is between 0.2 PHR and 0.5 PHR

21. The method according to claim 13,
wherein the proportion of graphene nano-platelet additive is between 0.5 PHR and 1.0 PHR.
